(19) United States
(12) Patent Application Publication
(10) Pub. No.: US 2010/0318429 A1
(43) Pub. Date: Dec. 16, 2010

(54) RELATIVE USAGE AND LOCATION OPTIMIZATION SYSTEM

(76) Inventor: James R. Birch, Spokane, WA (US)

Correspondence Address: KARL R CANNON, PO BOX 1909, SANDY, UT, 84091, US

(21) Appl. No.: 12/861,720

(22) Filed: Aug. 23, 2010

Related U.S. Application Data
(63) Continuation of application No. 12/756,134, filed on Apr. 7, 2010, now abandoned.
Application No. 12/756,134 is a continuation of application No. 12/544,981, filed on Aug. 20, 2009, now abandoned.
Application No. 12/544,981 is a continuation of application No. 12/326,009, filed on Dec. 1, 2008.
Application No. 12/326,009 is a continuation-in-part of application No. 12/177,079, filed on Jul. 21, 2008, now abandoned.
Application No. 12/177,079 is a continuation of application No. 12/074,549, filed on Mar. 3, 2008, now abandoned.
(60) Provisional application No. 60/928,318, filed on May 8, 2007.
(60) Provisional application No. 60/904,467, filed on Mar. 2, 2007.

(51) Int. Cl. G06Q 30/00

(52) U.S. Cl. 705/14.66; 705/14.73; 705/14.49; 705/14.69

(57) ABSTRACT

A system and method for rendering advertisements on electronic devices to consumers based upon one or more delivery requirements. The delivery requirements may specify that advertisements be rendered within a specified criteria after a change of state of an associated electronic device. In this manner, the present disclosure is able to maximize the effectiveness of the advertisements. In particular, after a change of state of an electronic device, a content stream may be monitored for an advertisement placement opportunity that satisfies a predetermined delivery requirement. After the advertisement placement opportunity is determined, an advertisement, such as a targeted advertisement, may be inserted into the content stream. The present disclosure may further include a pricing structure based upon the delivery requirement such that advertising providers pay a premium for advertisements rendered just after a change of state of an electronic device.

### CROSS-REFERENCE TO RELATED APPLICATIONS

This application is a continuation of U.S. application Ser. No. 12/756,134, filed Apr. 7, 2010, which is a continuation of U.S. application Ser. No. 12/544,981, filed Aug. 20, 2009, which is a continuation of U.S. application Ser. No. 12/326,009, filed Dec. 1, 2008, which is a continuation-in-part of prior U.S. application Ser. No. 12/177,079, filed Jul. 21, 2008, which is a continuation of prior U.S. application Ser. No. 12/074,549, filed Mar. 3, 2008, which claims the benefit of U.S. Provisional Application Nos. 60/928,318, filed May 8, 2007, and 60/904,467, filed Mar. 2, 2007, and, which are hereby incorporated by reference herein in their entirety, including but not limited to those portions that specifically appear hereinafter, the incorporation by reference being made with the following exception: In the event that any portion of the above-referenced applications are inconsistent with this application, this application supercedes said above-referenced applications.

### STATEMENT REGARDING FEDERALLY SPONSORED RESEARCH OR DEVELOPMENT

Not Applicable.

### BACKGROUND

1. The Field of the Invention.

The present disclosure relates generally to a system and method for rendering advertisements, and more particularly, but not necessarily entirely, rendering advertisements to users of electronic devices in association with predetermined delivery requirements.

2. Description of Related Art

Traditional advertisement methods involve broadcasting advertising and programming material together to multiple recipients in the same geographic area. For example, advertising and programming material may be broadcast through a television or radio station in a content stream available to all television sets within range of the station. In the traditional advertising model, advertisers pay for advertising slots in the programming. The pricing of the advertising is typically based upon the popularity of the underlying program. For example, advertisers generally pay a premium for advertising slots purchased during a highly rated sitcom while late night advertising slots may be fairly inexpensive.

One drawback to the traditional advertising model may be that it completely ignores the relative usage of a specific user and the number of advertisements seen by that user. In particular, the effectiveness of an advertisement is likely to be much greater just after the user turns on a television or switches a channel than after the user has been watching the television for an extended period of time. This is especially true where some statistics indicate that an average U.S. household watches over four hours of television per day. The reason for the greater effectiveness of advertisements shown immediately after the user begins watching the television is that the user has not become over saturated with advertisements and is therefore much more likely to pay attention to the advertisements rendered immediately after the user begins watching the television. In the past, advertisers and content providers have been unable to control the placement of advertisements based upon the relative usage of users.

Another drawback to the traditional advertising model may be that it does not take into account the relative location of the advertisement placement at the individual level, let alone the individual level. At best, under the traditional advertising model, an advertiser can only purchase a particular time slot, but the advertiser will have no control over whether that advertisement will be the first, second, third, and so forth, advertisement seen by the user.

Thus, traditional advertising models completely ignore the relative usage of a specific viewer and number of impressions the actual viewer has already been exposed to which can dramatically impact the value of that advertisement. For example, under the presently available advertising methods, if an advertiser purchased a 30-second time slot for 7:35 p.m., the advertiser has no idea if the user has been watching television all day or just turned the television on at 7:34 pm. As such, there is no way to control the relative placement of the advertisement with respect to a user—that is, the advertiser's advertisement could be the first or the one hundredth advertisement viewed by the user. In this sense, the advertiser has absolutely no control over the advertisement's placement using conventional advertising methods.

The prior art is thus characterized by several disadvantages that are addressed by the present disclosure. The present disclosure minimizes, and in some aspects eliminates, the above-mentioned failures, and other problems, by utilizing the methods and structural features described herein. The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is a diagram illustrating an embodiment of a system pursuant to the present disclosure;

FIG. 2 is a diagram illustrating an exemplary embodiment of the electronic device illustrated in FIG. 1;

FIG. 3 is a diagram illustrating an exemplary embodiment of the centralized management system illustrated in FIG. 1;

FIG. 4 is a diagram illustrating another embodiment of a system pursuant to the present disclosure;

FIG. 5 is a flow chart according to an embodiment of the present disclosure;

FIG. 6 is a flow chart according to an embodiment of the present disclosure;

FIG. 7 is a flow chart according to an embodiment of the present disclosure;

FIG. 8 is a flow chart according to an embodiment of the present disclosure;

FIG. 9 is a flow chart according to an embodiment of the present disclosure;

FIG. 10 is a flow chart according to an embodiment of the present disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “having,” “including,” “containing,” “characterized by,” and grammatical equivalents thereof are inclusive or open-ended terms that do not exclude additional, unrecited elements or method steps.

As used herein, the term “content stream” may mean information of an audio and/or visual nature that may be rendered through the use of an electronic device. The content stream may be embodied in a signal, including, without limitation, electromagnetic signals and light-based signals, either of a wired or wireless nature. The content stream may be embodied in a storage medium, including digital and analog storage mediums, such as hard drives, electronic memory, and optical storage mediums. The content stream may include information, including at least one of programming and advertisements. The content stream may be generated by a remote or local content source as described herein.

As used herein, the term “render,” and its grammatical equivalents, may mean to play, display, draw, interpret, decode, show, reproduce, or otherwise present the information in the content stream in a manner that can be perceived by a human. For example, the information in the content stream may be rendered to a user using a display, monitor, television, or screen in combination with speakers.

Further, many of the functional units described in this disclosure have been labeled as “modules,” in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software code operating on a computer, sometimes referred to as computer readable instructions, for execution by various types of microprocessors. An identified module of executable code may, for instance, include one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code operating on a computer may be a single instruction operating on a single computer, or many instructions operating on a single computer or on multiple computers, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Turning now to the present disclosure, applicant has discovered a system and method for allowing advertisement placement to be based upon relative usage and relative location with respect to an individual's use of an electronic device. The present disclosure may allow an advertiser to dictate that an advertisement be the first advertisement rendered to a user after the user has turned on the electronic device or changed the state of the electronic device. In this manner, the advertisement may have a greater impact upon the user. The present disclosure may further allow an advertiser to dictate that an advertisement be rendered to a user within a prespecified time interval after a change of state of the electronic device. For example, the advertiser may specify that the advertisement be rendered to the user within one-half of an hour after turning on the electronic device. Again, in this manner, the advertisement may have a greater effectiveness with respect to the user than compared to a traditional advertising method. The present disclosure may further facilitate a pricing structure for advertisement placement that is based upon the relative usage of the user and the relative location of the advertisement placement. Thus, advertisers may be charged a premium for the relative usage and placement of advertisements and/or content to specific users and the pricing of an advertisement may not solely be based upon the time slot. The present disclosure may be utilized in conjunction with a system that is able to disseminate targeted advertisements to specific users of electronic devices.

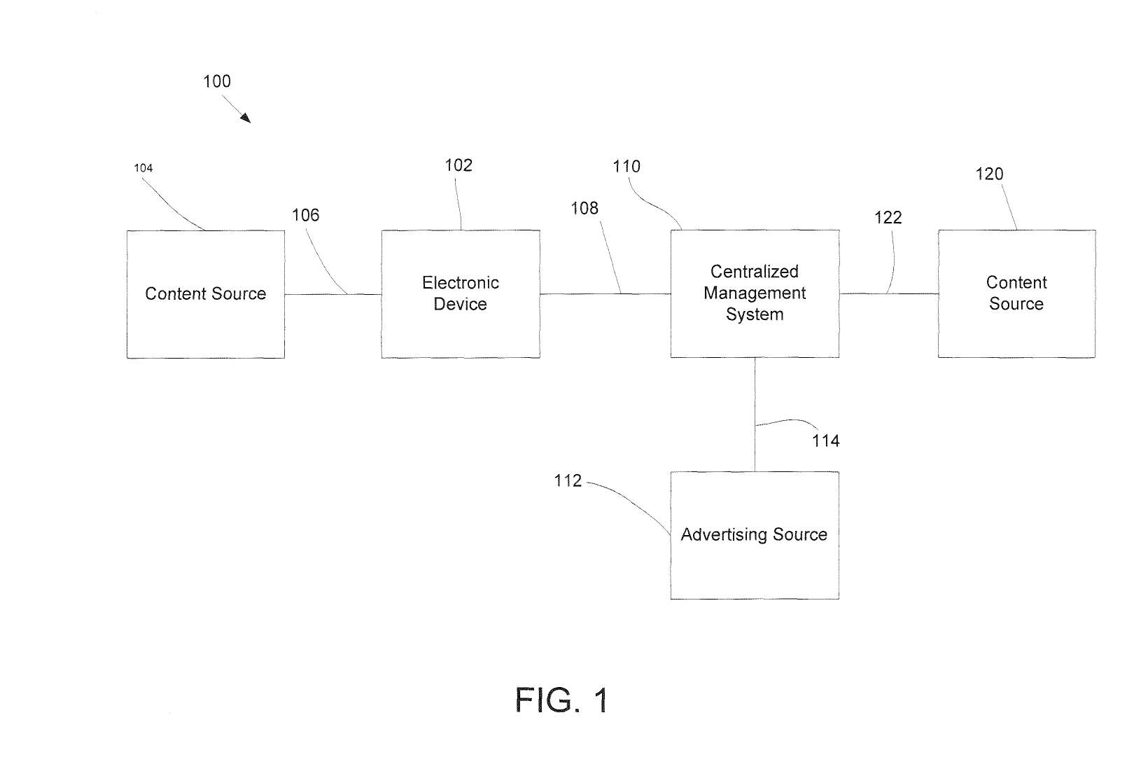

Referring now to FIG. 1, there is shown a diagram of an embodiment of a system 100 in accordance with the principles of an embodiment of the present disclosure. The system 100 may include an electronic device 102 and a centralized management system 110. The electronic device 102 may be operable to render a content stream to a user. In an embodiment of the present disclosure, the electronic device 102 may comprise a television. In an embodiment of the present disclosure, the electronic device 102 may comprise a cell phone. In an embodiment of the present disclosure, the electronic device 102 may comprise a computer, such as a handheld computer, a laptop computer, or a desktop computer. In an embodiment of the present disclosure, the electronic device 102 may comprise a portable or handheld electronic device, such as a digital music player (iPod®, mp3 player, etc.) and an internet access device. It will therefore be understood that the electronic device 102 may comprise any device that is able to render, either visually, audibly or otherwise, a content stream, to a user.

A content source 104 may provide a content stream to the electronic device 102 over a communication path 106. It will be appreciated that while only one content source 104 is depicted in FIG. 1, that any number of content sources may provide a content stream to the electronic device 102. For example, the electronic device 102 may have the ability to receive and tune different channels, such as television channels or radio channels. In an embodiment of the present disclosure, the electronic device 102 may access different websites. The communication path 106 between the content source 104 and the electronic device 102 may comprise a wireless communication path, a wired communication path, or a combination of both. In an embodiment of the present disclosure, the content source 104 may be located remotely from the electronic device 102. In an embodiment of the present disclosure, the content source 104 may be located proximate the electronic device 102. In an embodiment of the present disclosure, the content source 104 may be integrated into the electronic device 102.

The content source 104 may include, without limitation, a television station network, a communications satellite, a cable TV station, a gaming system, a web server, a cellular phone network, electronic memory, a computer server, a music player, a computer, a DVD player, a Blu-Ray disc player, an HD DVD player, a high definition optical player, a CD player, a VCR player, a tape recorder, personal video recorder (“PVR”), an IPTV station, and any other similar and equivalent devices, now known or known in the future, that are able to transmit content streams for rendering to the electronic device 102. It should therefore be understood that the content source 104 includes any device, apparatus, system or network capable of providing a content stream to the electronic device 102.

The content stream may be delivered to the electronic device 102 from the content source 104 over the communication path 106. As mentioned, the communication path 106 may comprise a wired or wireless portion. If the communication path 106 is a wireless communication path, the content stream may be transmitted using a radio frequency communication scheme such as those used for broadcast television, satellite TV, radio stations, pager networks, computer networks and cellular telephones. If the communication path 106 is a wired communication path, the content stream may be transmitted using a communication scheme commonly used for cable TV networks, computer buses, fiber optic networks, power line communication networks, telephone lines, twisted pair, CAT-5, RCA cables, HDMI cables, coaxial cables, or any other type of conductor or light transmission device used to carry analog or digital information. In short, it should be recognized that, pursuant to the present disclosure, there is no limitation on the medium through which the content stream may be delivered to the electronic device 102 from the content source 104.

It will be noted that the content stream may originate from information stored in any type of storage medium, including analog and digital storage mediums. For example, if the content source 104 is a gaming system, the content stream may be generated from information stored on a cartridge, CD, DVD, Blu-Ray disc, or an HD DVD disk. If the content source 104 is a web server, the content stream may be generated from information stored electronically on a computer-readable storage medium accessible by the web server. Further, the content stream may be generated on-demand in response to a request from the electronic device 102. In that regard, the communication path 106 may allow one-way or two-way communications.

The content stream provided by the content source 104 may be provided on-demand or pursuant to a fixed broadcast schedule. For example, in the case where the content source 104 is a web server, the content stream may be provided in response to a request from the electronic device 102. If the content source 104 is a television station or a radio network, the content stream may be broadcast pursuant to a fixed broadcast schedule. If the content source 104 is a gaming system, the content stream may be provided when the gaming system is turned on and the appropriate game is installed into the gaming system.

The content source 104 may provide the content stream in any one of a wide variety of media formats as is known to one having ordinary skill in the art. The only restriction on the formatting of the content stream is that it must be compatible for rending on the electronic device 102. Suitable formats for the content stream include all audio, video, media, proprietary, and other formats now known or known in the future. Suitable formats, include, without limitation, NTSC, HTML, DTV, AVI, Windows Media, MPEG-1, MPEG-2, MPEG-4, QuickTime, RealVideo, Flash and Shockwave. Other suitable formats include audio formats such as AAC, AC3, MID1, MP3, RealAudio, Waveform, and WMA. Other suitable formats include image formats such as BMP, GIF, JPG, JPG 2000, MNG, PNG, SVG, TIFF. Other suitable formats include ASCII, DOC, EBCDIC, HTML, OEBPS, RTF, Unicode, WPD, and XML. Still other suitable formats include the CD, DVD, Blue-Ray, and HD DVD formats. Further, it will be noted that the content stream may be first received at an intermediary device, such as a decoder, router, gateway, satellite receiver, a cable receiver, or a high definition receiver, and then delivered to the electronic device 102.

In an embodiment of the present disclosure, the content stream provided by the content source 104 may include programming and advertising. In an embodiment of the present disclosure, the content stream may include programming or advertising. As used herein, the term “programming” may refer to content that a user of the electronic device 102 wishes to access, and may include, without limitation, shows, movies, websites, games, graphical user interfaces, operating systems and music. The term “advertising,” as used herein, may refer to a paid or unpaid promotion for goods, services, companies and ideas by an advertiser. In addition, the term “advertising,” may refer to any type of solicitation of any kind.

In addition to receiving a content stream from the content source 104, the electronic device 102 may transmit and receive communications from the centralized management system 110 over a communication path 108. In an embodiment of the present disclosure, the centralized management system 110 may be located at a remote location, thereby requiring that the communication path 108 comprise a communications network. Suitable networks for the communication path 108 may include, without limitation, a computer network such as a local area network (“LAN”) or a wide area network (“WAN”). In an embodiment of the present disclosure, the communication path 108 may comprise a packet-switched network, such as the Internet. In an embodiment of the present disclosure, the communication path 108 may comprise a telephony network, such as a 3G network.

The communication path 108 between the centralized management system 110 and the electronic device 102 may be direct or in-direct. Further, the communication path 108 may use any one of a wide variety of transmission mediums, including a wireless communication path, a wired communication path, or a combination of both, and may span one or more different networks. The electronic device 102 and the centralized management system 110 may use the appropriate communications protocol to communicate with each other as is known by one having ordinary skill in the art. In an embodiment of the present disclosure, at least one user of the electronic device 102 may complete an enrollment process with the centralized management system 110. In an embodiment of the present disclosure, multiple users of the electronic device 102 may enroll with the centralized management system 110. For example, all of the members of a household may enroll with the centralized management system 110 as users of the electronic device 102.

The enrollment process may be completed through a wide variety of methods, including through the electronic device 102 itself, another electronic device, a live interview, or through completing a paper form. A graphical user interface, such as an interactive webpage or display, may be employed to assist in the enrollment process. In an embodiment of the present disclosure, the enrollment process may require that users complete a profile assessment by providing information in response to survey-type questions.

The enrollment process may obtain demographic information about users associated with the electronic device 102. In an embodiment of the present disclosure, the enrollment process may gather information regarding the ages of users, the sexes of users, the incomes of users, the marital and family status of users, the races of users, the residences of users, the native languages of users, credit information of users, the hobbies of users, the general and specific interests of users, and/or any other information deemed necessary to direct targeted advertisements to the users as is known to one have ordinary skill in the art. The profile and demographic information gathered from the users may be stored in a database associated with the centralized management system 110. The information may be used to generate user profiles for each user of the electronic device 102. In an embodiment of the present disclosure, the enrollment process may also allow a user to submit a biometric or non-biometric reference sample to be used in identifying the user.

As will now be explained in greater detail, the centralized management system 110 is able to deliver targeted advertisements to users of the electronic device 102 based upon the users' profiles. As used herein, the term “targeted advertisement” may mean an advertisement intended for a consumer having a specific profile or fitting a certain demographic in contrast to mass advertising. The targeted advertisements may be supplied to the centralized management system 110 from an advertising source 112. Once received at the centralized management system 110, the advertisements may be stored and maintained for future dissemination to the electronic device 102.

It will be appreciated that the advertising source 112 may be operated by a third-party, such as an advertising agency or by an in-house marketing department of a company. The advertising source 112 and the centralized management system 110 may engage in communications over a communication path 114. Through the communication path 114, the advertising source 112 may transmit the targeted advertisements to the centralized management system 110. The targeted advertisements may be provided by the advertising source 112 in a format suitable for transmission to the electronic device 102 by the centralized management system 110. Alternatively, the centralized management system 110 may have the capability to format or re-format a targeted advertisement for transmission to the electronic device 102 over the communication path 108. Further, the targeted advertisements may be provided to the centralized management system 110 on a portable storage medium, such as a CD or DVD.

In addition to the targeted advertisements, the advertising source 112 may provide target profiles associated with each of the targeted advertisements. The target profiles may define a desired target profile of one or more users to whom the targeted advertisements are directed. The target profiles for the targeted advertisements may be developed by using profile information, which may contain demographic and behavioral information, stored at the centralized management system 110.

Once a targeted advertisement and its associated target profile have been received at the centralized management system 110, the centralized management system 110 may execute an operation to compare the target profile for the advertisement to the profiles of enrolled users to thereby determine a group of targeted users to whom the targeted advertisement should be delivered. It will be appreciated by those having ordinary skill in the art that the profiles of the targeted users may be only a close match to the target profile and that an exact match is not required between the target profile and a user's profile. In an embodiment of the present disclosure, there is a 90% or higher match between the target profile and a user's profile in order for the user to be targeted. In an embodiment of the present disclosure, there is an 80% or higher match between the target profile and a user's profile in order for the user to be targeted. In an embodiment of the present disclosure, there is a 70% or higher match between the target profile and a user's profile in order for the user to be targeted.

The targeted advertisement provided by the advertising source 112 may include a promotion for a product or service. The targeted advertisement may comprise a political advertisement or some other solicitation. In an embodiment of the present disclosure, the advertising source 112 may provide a plurality of targeted advertisements that are intended to be rendered pursuant to a predetermined sequence to users in accordance with an advertising campaign. That is, an advertising campaign may specify that the targeted advertisements be shown in a specific order to each targeted user. Thus, the advertising source 112 may also provide predetermined sequencing requirements for a plurality of targeted advertisements associated with an advertising campaign to the centralized management system 110 via the communication path 114.

In addition to providing a targeted advertisement and related target profile, the advertising source 112 may also specify one or more delivery requirements for the targeted advertisement. Delivery requirements may specify the relative placement of the advertisement in a content stream received by the electronic device 102. In an embodiment of the present disclosure, the delivery requirement may specify that the advertisement be rendered within a certain range from a change of state of an electronic device. For example, the delivery requirement may specify that the targeted advertisement be rendered with a certain time interval from a change of state of the electronic device 102. A delivery requirement may specify that the targeted advertisement be rendered with a certain number of advertisements from a change of state of the electronic device 102. In an embodiment of the present disclosure, a delivery requirement may specify the ordinal, i.e., first, second, third, etc., for rendering the targeted advertisement from a change of state of the electronic device 102.

In an embodiment of the present disclosure, a change of state of the electronic device 102 may refer to a state change from off to on. A change of state of the electronic device 102 may also include a change in channel, a volume adjustment, or any other change of state of the electronic device 102 initiated by a user. It will be appreciated that an advertisement rendered to a user soon after a change of state in the electronic device 102 may likely be more effective than an advertisement rendered after the electronic device 102 has been on for several hours.

In an embodiment of the present disclosure, the centralized management system 110 may comprise a pricing structure based upon the delivery requirements. That is, the pricing of the advertisement placement on the electronic device 102 may depend on the particular delivery requirements selected by the advertising source 112. As will be explained in more detail hereinafter, a premium may be charged for the placement of targeted advertisements immediately after a change of state. Further, certain changes of state may dictate even a higher premium. For example, an advertisement rendered immediately after a change in state of the electronic device 102 from off to on, may command the highest premium since a user is more likely to be more receptive at this time than after several hours of using the electronic device 102.

The centralized management system 110 may include an electronic storage medium for storing information received from the advertising source 112, information received from the electronic device 102, and information generated by the centralized management system 110. The centralized management system 110 may cause that targeted advertisements, target profiles, delivery requirements, and/or user profile information are stored locally at the centralized management system 110. In a manner that will be described in more detail hereinafter, the centralized management system 110 may disseminate the targeted advertisements, the identification of the targeted user, and any associated delivery requirements to the electronic device 102. The targeted advertisement and delivery requirement may be electronically stored locally to the electronic device 102. In an embodiment of the present disclosure, the centralized management system 102 may disseminate the targeted advertisement and associated delivery requirement to a plurality of electronic devices 102.

Each targeted advertisement disseminated to the electronic device 102 may be linked to a known user of the electronic device 102. The electronic device 102 may then access the targeted advertisement and render it to the targeted user of the electronic device 102 as specified in the link when it is determined that the targeted user is actually using the electronic device 102. The targeted advertisements may be rendered to a targeted user in accordance with advertisement placement opportunities in the content stream from the content source 104. Where a delivery requirement is associated with the targeted advertisement, the advertisement placement opportunity may meet the delivery requirement. In an embodiment of the present disclosure, the targeted advertisement may displace original advertising in the content stream.

In addition to the targeted advertisements, the centralized management system 110 may further provide a subscription-based content stream to the electronic device 102 over the communication path 108. The subscription-based content stream may be stored locally at the electronic device 102 in a storage medium for rendering on-demand at a later time. The subscription-based content stream may include customized programming selected by a user of the electronic device 102. The user may request the subscription-based content stream in a variety of manners. In one embodiment, a user may simply select the desired programming through a user interface of the electronic device 102. The user interface may be a graphical user interface. For example, the graphical user interface may list programming available from the centralized management system 110. The programming may include television programs, movies, news, music and sporting events. The subscription-based content streams may also include subject matter based content. That is, a user may elect to receive programming related to a particular topic. For example, the user may select to receive programming related to a particular sports team, actor, hobby, or event. The centralized management system 110 would, in response, deliver the programming selected by the user in a content stream. The subscription-based content stream may be rendered in real-time on the electronic device 102. Alternatively, the subscription-based content stream is stored at the electronic device 102 for later rendering at a time convenient to the user. Control over the rendering of the subscription-based content stream may be done through a user interface associated with the electronic device 102.

It will be appreciated that the subscription-based content stream allows the delivery of programming that may otherwise be unavailable. For example, a user may desire to receive a news broadcast from a television station that does not broadcast in the geographical area where the user resides. The subscription-based content stream delivered from the centralized management system 110 allows the user to receive the news broadcast. Further, the user is able to view the news broadcast at his or her leisure thereby freeing the content stream from a fixed broadcast schedule. Further, it will be appreciated that the ability of the centralized management system 110 to deliver the content stream directly to the electronic device 102 allows the user to select only the programming that the user desires.

In an embodiment of the present disclosure, the user may select to receive television shows from multiple different channels. These television shows are delivered in the subscription-based content stream from the centralized management system 110 to the electronic device 102. The user may then view the television shows as if they were all broadcast on a single channel. In this sense, the user is able to watch a “virtual channel” of programming selected by the user. Thus, it will be appreciated that the user can select to receive sporting events, movies, television shows, news broadcasts, music, talk radio shows, or any other programming available from the centralized management system 110.

The centralized management system 110 may not be limited to any one content source and could offer content from a wide variety of content sources, including television networks, movie studies, radio stations, and even independent content sources. In an embodiment of the present disclosure, the centralized management system 110 may allow a user to select to receive programming in a native language of the user that would otherwise be unavailable. Further, the subscription-based content stream may be provided to the centralized management system 110 by an outside content source 120 over a communication path 122. It will be appreciated that the centralized management system 110 may receive the subscription-based content stream from a multiple outside content sources, including content source 104. Thus, the present disclosure allows programming that would not otherwise merit a dedicated “channel” to be delivered to the electronic device 102.

The present disclosure may also allow for advertisements to be placed in relation to the subscription-based content streams. In an embodiment of the present disclosure, advertisements may be placed into the subscription-based content streams at the centralized management system 110. The subscription-based content streams are subsequently transmitted to the electronic device 102 together. In another embodiment, the advertisements may be inserted into the subscription based content streams at the electronic device 102. Thus, in this embodiment, the subscription-based content stream and the advertisements may be separately transmitted to the electronic device 102 by the centralized management system 110. The advertisements placed into the subscription-based content stream may be targeted to a specific user of the electronic device 102. Alternatively, the advertisements may be placed into the subscription-based content stream based upon some other criteria, or even no criteria at all. Thus, if a user selects to receive specific content stream, e.g., a television show, from the centralized management system 110, the content stream would be rendered at the electronic device 102 with the advertisements added at the centralized management system 110 or at the electronic device 102.

As previously mentioned, the targeted advertisements, delivery requirements, and, if transmitted, the subscription-based content stream, may be stored in a storage medium locally associated with the electronic device 102. When it is determined that the targeted user is actually using the electronic device 102, the electronic device 102 may render the targeted advertisement to the user at the first available advertisement placement opportunity in accordance with any delivery requirements. The determination that the targeted user is actually using the electronic device 102 may be accomplished through a biometric or non-biometric recognition technique using the reference sample submitted by the user during the enrollment process.

The rendering of the targeted advertisement to a targeted user may be accomplished in several ways. In an embodiment of the present disclosure, upon verification that a targeted user is actually using the electronic device 102, the electronic device 102 may begin monitoring the content stream from the content source 104 or the subscription based content stream from the centralized management system 110 for advertisement placement opportunities. In response to identifying an advertisement placement opportunity, the electronic device 102 may render the targeted advertisement in accordance with the advertisement placement opportunity. The placement of the targeted advertisement may, however, be subject a delivery requirement. In this case, the electronic device may render an advertisement at the first advertisement placement opportunity that satisfies the delivery requirement.

In addition, the communications between the centralized management system 110 and the advertising source 112 may include a report regarding the placement of the targeted advertisement. Likewise, the communications between the centralized management system 110 and the content source 120 may include a report regarding the placement of the targeted advertisement. Thus, the electronic device 102 may report feedback to the centralized management system 110 over the communication path 108. The feedback may include an electronic notification reporting that one or more targeted advertisements transmitted by the centralized management system 110 to the electronic device 102 has in fact been rendered to the targeted user. This feedback may allow the centralized management system 110 to track the delivery of the targeted advertisements.

Although only one advertising source 112 is depicted in FIG. 1, it will be appreciated by those having ordinary skill in the art that the centralized management system 110 may receive targeted advertisements from multiple advertisement sources. In this manner, the centralized management system 110 is able to deliver targeted advertisements from multiple advertisement sources. Further, it will be appreciated by those having ordinary skill in the art, that multiple users may enroll with the centralized management system 110 for the electronic device 102.

Moreover, although only one electronic device 102 is depicted in FIG. 1, it will be appreciated by those having ordinary skill in the art that multiple electronic devices, each having one or more users, may receive targeted advertisements from the centralized management system 110. In this manner, the centralized management system 110 is able to deliver targeted advertisements and associated delivery requirements, if any, across multiple platforms to multiple users.

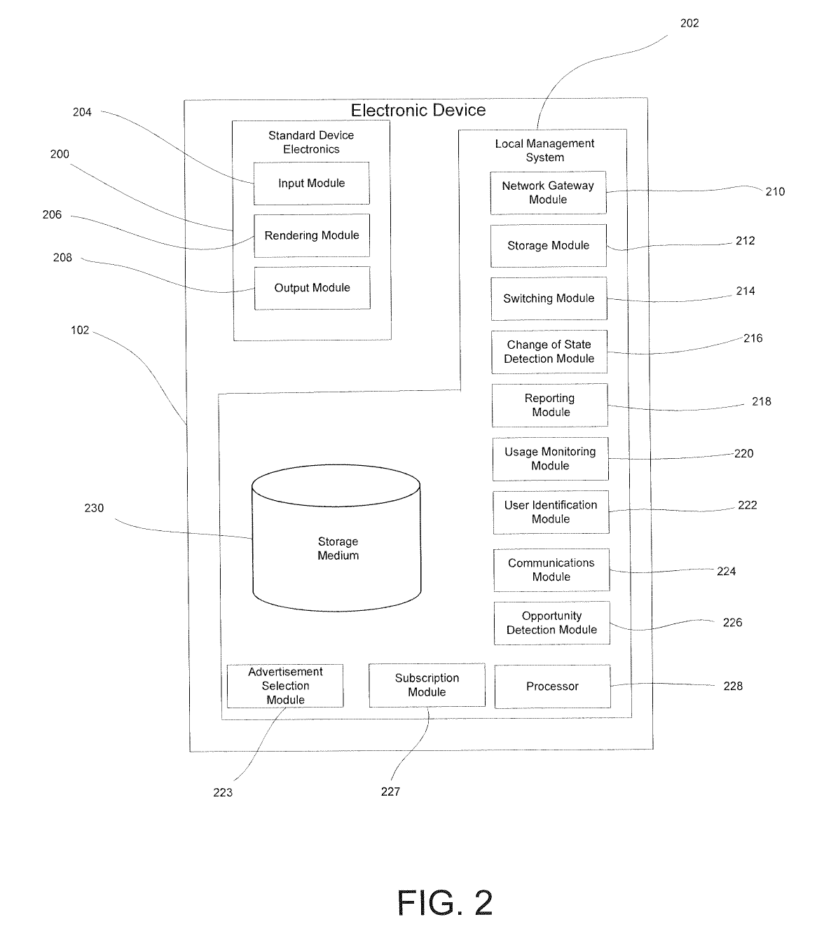

Referring now to FIG. 2, there is illustrated a diagram of the logical and other components of the electronic device 102 pursuant to an embodiment of the present disclosure. As previously mentioned, the present disclosure is not limited to any particular type of electronic device 102. An electronic device 102 may comprise, without limitation, televisions, cellular phones, computers, personal digital assistants and portable music players. Thus, it is to be understood by those having ordinary skill in the art that the features disclosed in relation to FIG. 2 may be incorporated into a wide range of electronic devices having the ability to render a content stream.

The electronic device 102 may include standard device electronics 200 and a local management system 202. The standard device electronics 200 may be those components typically associated with the type of electronic device 102. For example, if the electronic device 102 is a television, then the standard device electronics 200 may include those components typically found in a conventional television. Likewise, if the electronic device 102 is a computer, then the standard device electronics 200 may include those components typically found in a conventional computer. Additionally, if the electronic device 102 is a cellular phone, then the standard device electronics 200 may be those components typically found in a cellular phone.

In an embodiment of the present disclosure, the standard device electronics 200 may include an input module 204, a rendering module 206, and an output module 208. The input module 204 may be operable to receive a signal carrying a content stream from the content source 104 and may comprise all the necessary circuitry and related software to accomplish this task as is known to one having ordinary skill in the art. For example, if the content stream is received via a wireless connection, then the input module 204 may include an antenna and associated radio frequency circuitry, including a radio receiver chipset, necessary to receive the signal. Likewise, if the content stream is received via a wired connection, the input module 204 may include the appropriate connection jacks and the necessary circuitry and software to accomplish this task. The input module 204 may include a modem, a network card, and any other circuitry, hardware, decoder, and software necessary to receive the content stream.

The rendering module 206 may be operable to transform the content stream from the received form into an appropriate form compatible with the output module 208. The rendering module 206 may render at least one of digital and analog signals. The output module 208 may comprise a display, including an electronic display, screen, monitor, and/or speakers. The output module 208 may allow a user to actually perceive the content stream as rendered by the rendering module 206. It will be appreciated that the structure and apparatus disclosed herein is merely one example of a means for displaying an advertisement, and it should be appreciated that any structure, apparatus or system for displaying an advertisement which performs functions the same as, or equivalent to, those disclosed herein are intended to fall within the scope of a means for displaying an advertisement, including those structures, apparatus or systems for displaying an advertisement which are presently known, or which may become available in the future. Anything which functions the same as, or equivalently to, a means for displaying an advertisement falls within the scope of this element.

The local management system 202 may include the various modules as will now be described. A network gateway module 210 may be operable to allow communications between the electronic device 102 and the centralized management system 110. In an embodiment of the present disclosure, the network gateway module 210 may comprise a connection to a LAN or a WAN. In an embodiment of the present disclosure, the network gateway module 210 may allow communications to be received and transmitted over a network, such as the Internet. In particular, the network gateway module 210 may facilitate the communications with the centralized management system 110 over the communication path 108 (see FIG. 1).

Advertisements, delivery requirements and the identification of a targeted user may be received through the network gateway module 210. In an embodiment of the present disclosure, the network gateway module 210 and the input module 204 may share components if the communication paths between the content source 104 and the centralized management system 110 are the same or similar. In an embodiment of the present disclosure, the network gateway module 210 may comprise at least one of a modem, a network card and a high speed Internet connection.

The storage module 212 may be operable to control the storage of information in a digital storage medium 230 and may include the appropriate software and hardware drivers to effectuate the same. The information stored on the storage medium 230 may include advertisements, delivery requirements, targeted user information, and one or more content streams, as well as any other needed information or computer programming required to accomplish the tasks and features as described herein. It will be appreciated that the structure and apparatus disclosed herein is merely one example of a means for electronically storing an advertisement, and it should be appreciated that any structure, apparatus or system for electronically storing an advertisement which performs functions the same as, or equivalent to, those disclosed herein are intended to fall within the scope of a means for electronically storing an advertisement, including those structures, apparatus or systems for electronically storing an advertisement which are presently known, or which may become available in the future. Anything which functions the same as, or equivalently to, a means for electronically storing an advertisement falls within the scope of this element.

A switching module 214 may be operable to cause that the advertisements received from the centralized management system 110 are rendered on the electronic device 102 according to advertisement placement opportunities. In an embodiment of the present disclosure, the switching module 214 may comprise a switch capable of switching between the content stream from the content source 104 and the advertisements stored on the storage medium 230. Thus, the switching module 214 may dynamically switch back and forth the source for the rendering module 206 between the content stream from the content source 104 and the advertisements, which may be stored locally at the electronic device 102.

It will be appreciated that the structure and apparatus disclosed herein is merely one example of a means for switching between a content stream and an advertisement, and it should be appreciated that any structure, apparatus or system for switching between a content stream and an advertisement which performs functions the same as, or equivalent to, those disclosed herein are intended to fall within the scope of a means for switching between a content stream and an advertisement, including those structures, apparatus or systems for switching between a content stream and an advertisement which are presently known, or which may become available in the future. Anything which functions the same as, or equivalently to, a means for switching between a content stream and an advertisement falls within the scope of this element.

A change of state detection module 216 may monitor for an occurrence of a change of state of the electronic device 102. The change of state detection module 216 may monitor for a change of state from off to on. The change of state detection module 216 may monitor a change of state from one channel to another channel. The change of state detection module 216 may monitor any change of state of the electronic device 102 initiated by a user, including volume adjustment.

A reporting module 218 may generate feedback and other information transmitted to the centralized management system 110. The feedback may include, for example, information verifying the rendering of a targeted advertising to the targeted user.

A usage monitoring module 220 may monitor the usage of the electronic device 102 by a user. In particular, the usage monitoring module 220 may monitor an amount of time a particular user uses the electronic device 102. Through the usage monitoring module 220, for example, usage information may be determined that a user uses the electronic device 102 a certain amount of time per day, week, month, etc. The usage information may be included in a report sent by the reporting module 218 to the centralized management system 110.

A user identification module 222 may be operable to identify the user of the electronic device 102. The user identification module 222 may incorporate integrated technologies that passively identify a user of the electronic device 102. As used herein, the term “passively” means that a user may not be actively aware of the operation of the user identification module 222 or that the electronic device 102 may not require a specific user input to trigger the delivery of any targeted advertisements. In an embodiment of the present disclosure, the user identification module 222 may utilize a biometric recognition technologies and techniques. Suitable biometric recognition technology may include fingerprint recognition, retina recognition, heartbeat recognition, voice recognition, face recognition, and any other technology now known or known in the future that utilizes a measurable, physical characteristic or personal behavioral trait that may be used to recognize the identity, or verify the claimed identity, of a user. Other passive identification options for non-biometric technologies and techniques include associating a specific user with a cellular phone number, a serial number of an electronic device, or IP address assigned to an electronic device. The user identification module 222 may then identify a user based on the proximity of a known user mobile device associated with a specific cellular phone number, serial number, or IP address. The user identification module 222 may also use active identification technologies such as passwords, logins, and challenge questions to identify the user.

In the case where the user identification module 222 employs a biometric recognition technology, prior enrollment by the user may be required. That is, a user may be required to submit a reference sample of the characteristic or trait used to identify the user as previously described. Once taken, the reference sample may be stored at the centralized management system 110 or locally in the storage medium 230. The reference sample may be disseminated to the electronic device 102 associated with the user through the communication path 108. It will be appreciated that the reference sample for a user may be disseminated to multiple electronic devices 102 such that the user may only have to provide the sample one time. The user identification module 222 may include the necessary components to capture the user's characteristic or trait. For example, in the case where the biometric technology utilizes finger print recognition, the user identification module 222 may include a fingerprint scanner. Once the user's fingerprint is scanned, the scan is compared to the reference sample to thereby identify the user.

Once a user's identity is determined, or, stated another way, the user of the electronic device 102 is determined to have previously enrolled with the centralized management system 110, an advertisement selection module 223 may determine if any targeted advertisements stored in the storage medium 230 are linked to the identified user. If a targeted advertisement is linked to the current user of the electronic device 102, then the advertisement selection module 223 may then notify the switching module 214 and an opportunity detection module 226 that a targeted advertisement needs placement. If there are no targeted advertisements, the advertisement selection module 223 may not take any action.

A communications module 224 may be operable to control communications between the electronic device 102 and the centralized management system 110 through the network gateway module 210.

As discussed, the opportunity detection module 226 may be operable to recognize advertisement placement opportunities in relation to a content stream from the content source 104. For example, the opportunity detection module 226 may identify an advertising placement opportunity in a content stream for an advertisement received from the centralized management system 110. In order to identify an advertisement placement opportunity, the opportunity detection module 226 may monitor the content stream for embedded codes that signal an upcoming “time slot” designated for advertising. The embedded codes may take the form of an inaudible tone or any other type of signaling or flag. Once an upcoming slot designated for advertising has been identified, the opportunity detection module 226 may cause that the original advertisements in the content stream be displaced by the targeted advertisements received from the centralized management system 110 using the switching module 214. If the content stream is HTML coding that defines a webpage, the opportunity detection module 226 may cause a banner ad in the content stream to be swapped with an advertisement, also a banner ad, from the centralized management system 110.

If a particular advertisement is associated with a delivery requirement, the opportunity detection module 226 may determine an advertisement placement opportunity that satisfies the delivery requirement. The opportunity detection module 226 may therefore function cooperatively with the change of state detection module 216, if needed, to ensure that the advertisement placement opportunity satisfies any associated delivery requirements for an advertisement.

It will be appreciated that the structure and apparatus disclosed herein is merely one example of a means for determining an advertisement placement opportunity for the advertisement, and it should be appreciated that any structure, apparatus or system for determining an advertisement placement opportunity for the advertisement which performs functions the same as, or equivalent to, those disclosed herein are intended to fall within the scope of a means for determining an advertisement placement opportunity for the advertisement, including those structures, apparatus or systems for determining an advertisement placement opportunity for the advertisement which are presently known, or which may become available in the future. Anything which functions the same as, or equivalently to, a means for determining an advertisement placement opportunity for the advertisement falls within the scope of this element.

A subscription module 227 may manage the subscription-based content stream from the centralized management system 110. The subscription module 227 may be operable to generate a graphical user interface to allow a user to select individualized content or programming available from the centralized management system 110. In this regard, the centralized management system 110 may transmit to the electronic device 102 over the communication path 108 a list of all available content and programming, which is then displayed by the subscription module 227 to a user on the electronic device 102.

The local management system 202 may also include a microprocessor 228, also known as a centralized processing unit. As the various modules 210-227 may include computer programming code to accomplish the features as described herein, the modules 210-227 may utilize the microprocessor 228 to accomplish their intended purposes as outlined herein. In an embodiment of the present disclosure, the microprocessor 228 may be incorporated into the modules 210-227.

It will be appreciated that the local management system 202 may be integrated into the electronic device 102 or may be contained in a separate and stand-alone unit having a connection to the electronic device 102, i.e., the standard device electronics 200. It will further be noted that any of the modules 210-227 may also be integrated into the electronic device 102, or any or all of them may be externally located with respect to the electronic device 102. Further, an omission of one or more of the modules 210-227 in an electronic device 102 still falls within the scope of the present disclosure. That is, embodiments of the present disclosure may have less than all of the modules 210-227 shown in FIG. 2. Further, the modules 210-227 may share common resources, including software and hardware, without departing from the scope of the present disclosure.

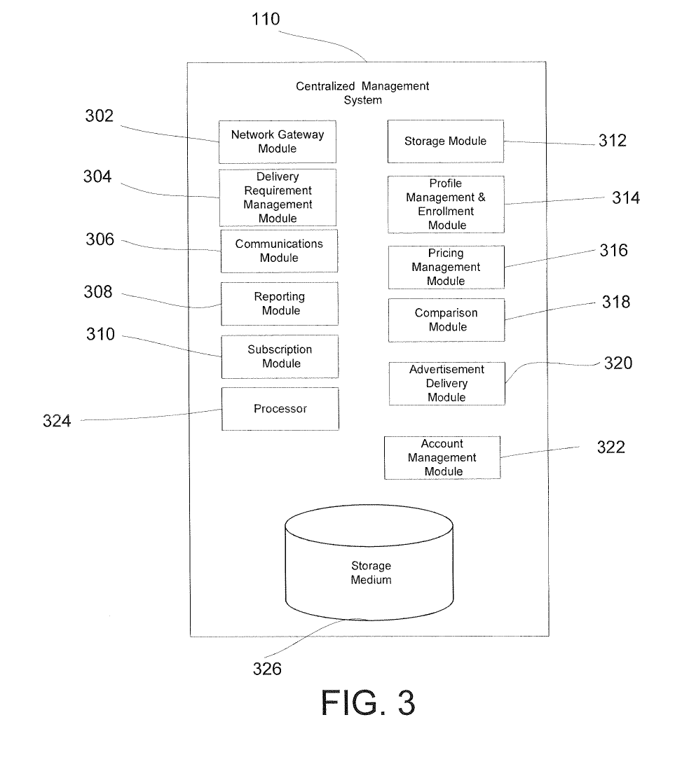

Referring now to FIG. 3, there is illustrated a diagram of the logical and other components of an exemplary embodiment of a centralized management system 110. As mentioned above, the centralized management system 110 may be remotely located from the electronic device 102 such that the centralized management system 110 is able to communicate with a plurality of electronic devices over a network. Indeed, it will be appreciated the centralized management system 110 may connect to thousands or millions of electronic devices via one or more networks. Various components of the centralized management system 110 will now be described.

A network gateway module 302 may be operable to allow communications between the electronic device 102 and the centralized management system 110. The network gateway module 302 may provide a connection to a network, such as a LAN or a WAN. In an embodiment of the present disclosure, the network gateway module 302 may allow communications to be received and transmitted over a network, such as the Internet or a proprietary network.

A delivery requirement management module 304 may allow for the establishment of delivery requirements for one or more advertisements. Once established, a delivery requirement may be disseminated to the electronic device 102. In particular, the delivery requirement management module 304 may allow an operator to define delivery requirements for advertisements disseminated to the electronic device 102 from the centralized management system 110. In an embodiment of the present disclosure, the delivery requirement may be at least one of an ordinal restriction, a time restriction, and a number restriction relative to a change in state of the electronic device 102. An ordinal restriction may require that an advertisement be rendered on the electronic device 102 in a certain location in a content stream. For example, an ordinal restriction may require that an advertisement be rendered in the first, second, third, etc., available advertisement placement opportunity after a change of state of the electronic device 102. A time restriction may require that an advertisement be rendered on the electronic device 102 within a certain time interval after a change of state of the electronic device 102. A number restriction may require that an advertisement be rendered with a certain interval of advertisements rendered on the electronic device 102.

A communications module 306 may be operable to control communications between the electronic device 102 and the centralized management system 110 and the centralized management system 110 and the advertisement source 112. For example, the communications module 306 may identify preferred communication times to disseminate information to the electronic device 102. The communication module 306 may track successful and unsuccessful communications and repeat as often as is necessary. The communication module 306 may be completely autonomous from human interaction such that the communications with the electronic device 102 may occur automatically. The communications module 306 may send the communications through the network gateway module 302.

A reporting module 308 may be operable to generate reports regarding the advertisement placement and also any fees due for the advertisement placement. The reports may be generated automatically pursuant to a reporting policy established by the operators of the centralized management system 110. The reports generated by the reporting module 308 may include information received from the reporting module 218 (see FIG. 2) of the electronic device 102.

A subscription module 310 may be operable to provide a subscription-based content stream having customized content to the electronic device 102. For example, as explained previously, a user of the electronic device 102 may be able to interactively select programming and other content for delivery to the electronic device 102 from the centralized management system 110. Targeted advertisements may be placed into the subscription-based content stream at the centralized management system 110 prior to transmission to the electronic device 102. This may be done on-the-fly as the subscription-based content stream is transmitted. Alternatively, the subscription-based content stream may be transmitted to the electronic device 102 separately from the targeted advertisements. Thus, the subscription module 310 that may be operable to allow a user to subscribe to any content stream available from the centralized management system 110. As mentioned, the content stream may be provided by an outside content source 120 (see FIG. 1) over the communication path 122 to the centralized management system 110. It is contemplated that the present disclosure includes receiving content streams from multiple content sources and making them available to the electronic device.

The subscription module 310 may provide a list of all available content streams to the electronic device 102 to thereby facilitate user selection at the electronic device 102. The subscription module 310 may provide navigable menu screens to the electronic device 102 such that the user may select from available programming. For example, the screens may include all available movies, shows, programming or other content available for delivery to the electronic device 102 through the centralized management system 110. As discussed above, the content for the subscription-based content stream may be provided to the centralized management system 110 by an outside content source 120 over a communication path 122 (see FIG. 1).

The centralized management system 110 may include a storage module 312 that is operable to manage and control the storage of information in a storage medium 326. The storage module 312 may include a database management application suitable for the purposes outlined herein. The storage module 312 may include the appropriate software drivers for accessing information from the storage medium 326.

The centralized management system 110 may include a user profile management and enrollment module 314 that may be operable to receive and manage user profiles in a database environment on the storage medium 326. A user profile may include demographic information regarding a user of the electronic device 102. The user profile management and enrollment module 314 may administer an on-line profile assessment to a user to thereby enroll the user with the centralized management system 110. The user profile management and enrollment module 314 may also receive and store biometric reference samples from users as part of the users profile. In addition, the user profile management and enrollment module 314 may also associate all of the electronic devices of a user with the user's profile. The user profile management and enrollment module 314 may further receive and manage user usage information from the usage monitoring module 220 of the electronic device 102 (see FIG. 2) regarding a user or each user enrolled with the centralized management system 110.

The centralized management system 110 may also include a pricing management module 316 that is operable to manage and control the pricing of the placement of the targeted advertisements. As previously intimated, the advertising source 112 (see FIG. 1) may be charged for use of the features of the centralized management system 110. The pricing management module 316 may be utilized to vary the pricing of advertisement placement depending upon the delivery requirements. In general, the pricing management module 316 may be utilized to establish a pricing structure that may include a premium for advertisements rendered when the user is likely to be more attentive and receptive to an advertisement. In particular, the sooner an advertisement is rendered after a change of state of the electronic device 102, the higher the price for that advertisement. The pricing structure may utilize a percentage scale. The present disclosure allows for the pricing of advertisement placement to be based upon a parameter from a predetermined event, including an ordinal requirement for advertisement placement, the relative timing of the advertisement placement, and the relative number of advertisements rendered to a user before advertisement placement. Thus, it will be appreciated that the pricing management module 316 may implement a pricing structure based upon a parameter as determined from a predetermined event.

In regard to the ordinal delivery requirement, Table 1, below, illustrates an exemplary pricing structure.

TABLE 1

| Ordinal | Device Turn On Pricing | Content Change Pricing |
|---|---|---|
| 1^{st} | 100% | 80% |
| 2^{nd} | 50% | 40% |
| 3^{rd} | 30% | 25% |
| 4^{th} | 25% | 20% |
| 5^{th} | 20% | 10% |

For example, if the advertisement is inserted into the first available advertisement placement opportunity after the electronic device 102 is turned on, i.e., a change of state, then the advertisement provider pays 100% of the advertising charge. If however, the advertisement is inserted into the fourth available advertisement placement opportunity after the electronic device 102 is turned on, then the advertisement provider pays 25% of the advertising charge. Thus, an advertisement provider may pay a premium for an advertisement placement rendered in the first advertisement placement opportunity due to the fact that the user is more likely to pay attention to the first advertisement rendered. Likewise, where there has been a content change, such as a channel change, on the electronic device 102 an advertisement provider may pay 80% of the advertisement charge to have its advertisement placed first after the change due to the fact that the user may be more likely to pay attention.

In regard to the relative timing of the advertisement placement, Table 2, below, illustrates an exemplary pricing structure.

TABLE 2

| | |
|---|---|
| Time Device Has Been On | Pricing |

| | | |
|---|---|---|
| <.5 | hour | 100% |
| .5-1 | hour | 75% |
| 1-2 | hour | 50% |
| 2-4 | hour | 25% |
| >4 | hours | 0% |

For example, if the advertisement is rendered within the first one-half hour after the electronic device 102 has been turned on, then the advertisement provider pays 100% of the advertising charge. If however, the advertisement is rendered between 2-4 hours after the electronic device 102 has been turned on, then the advertisement provider pays 25% of the advertising charge. Thus, an advertisement provider may pay a premium for an advertisement placement just after the electronic device 102 has been turned on as compared to after the electronic device 102 has been on for several hours. This exemplary pricing structure is designed to charge a premium for advertisements that are rendered during the most effective time intervals.

In regard to the relative number of advertisements seen by a user, Table 3, below, illustrates an exemplary pricing structure.

TABLE 3

| Number of Advertisements | |
|---|---|
| Seen by A User | Pricing |
| <5 | 100% |
| 5-10 | 75% |
| 10-20 | 50% |
| 20-50 | 25% |
| >50 | 0% |

For example, if the advertisement is rendered within the first five advertisements seen by a user of the electronic device 102 after a change in state of the electronic device 102, then the advertisement provider pays 100% of the advertising charge. If however, the advertisement rendered between 20-50 advertisements seen by a user, then the advertisement provider pays 25% of the advertising charge. Thus, an advertisement provider may pay a premium for early advertisement placement before the user has been saturated with a large number of advertisements. Further, it will be appreciated that the above pricing structures are based upon parameters as determined from a change of state of an electronic device. The parameters may include an ordinal, a time interval, or a number of advertisement seen by a user.

The centralized management system 110 may include a comparison module 318 that is operable to compare the target profiles for any targeted advertisements to the user profiles to thereby determine a group of targeted users. At this point, the centralized management system 110 may generate feedback to the advertisement source 112 regarding the group of targeted users. This feedback may include information regarding the number of users in the group of targeted users. This information may allow the modification of the target profile such that the size of the group of targeted users may be increased or decreased. This process may undergo several iterations until a desired group of targeted user profiles has been generated.

After the targeted users have been identified and finalized by the comparison module 318, the centralized management system 110 may disseminate the targeted advertisements and the delivery requirement, if any, to the electronic device 102 associated with each of the targeted users via the advertisement delivery module 320. The advertisement delivery module 320 may also transmit a link associated with a targeted advertisement. The link may identify the targeted user to whom the targeted advertisement is to be directed. In this manner, the electronic device 102 may utilize the link to ensure proper delivery of the targeted advertisement to the targeted user.

It should be noted that users enrolled with the centralized management system 110 who do not have a matching profile to the targeted profile may not receive the targeted advertisements. The dissemination of the targeted advertisements to the electronic devices 102 of the targeted users may take place as the system 110 demands allow. Typically, this may occur during off-peak hours. Further, the process may occur over several hours, days or weeks depending upon the size of the group of targeted users.

An account management module 322 may be operable to establish and manage accounts of advertisement providers. (An advertisement provider may operate the advertising source 112.) The account management module 322 may keep track of the amounts owed by the advertisement providers based upon the established pricing structure.

The centralized management system 110 may include a microprocessor 324, also known as a central processing unit, that is operable to process any of the required data from any of the modules 302-322. The processor 324 may take any one of a variety of forms including a single processor or multiple processors. The processor 324 may be included in one or more of the modules 302-322. Further, it will be appreciated that the centralized management system 110 may be integrated into a single computing device or may be distributed across multiple computing platforms. It will further be noted that the modules 302-322 may also be integrated into a single computing device or may be separately located amongst multiple computing platforms. Further, omission of one or more of the modules 302-322 falls within the scope of the present disclosure. That is, alternative embodiments of the present disclosure may have less than all of the modules 302-322 shown in FIG. 3.

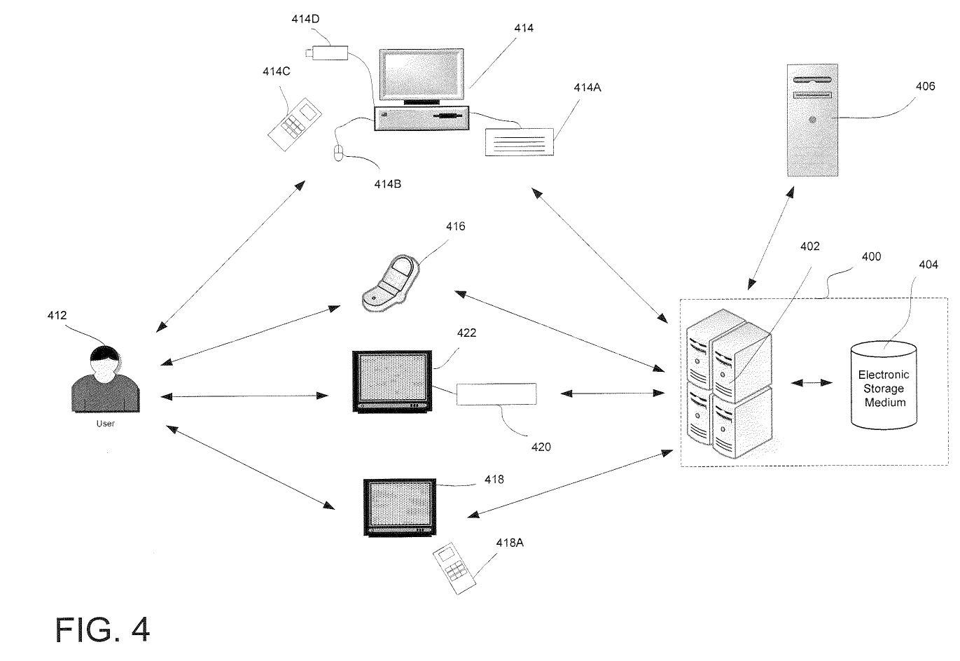

Referring now to FIG. 4, there is shown another exemplary embodiment of the present disclosure. A centralized management system 400 may comprise one or more computing devices 402 in communication with an electronic storage medium 404. The centralized management system 400 may receive targeted advertisements in an electronic format from a computing device 406. The computing device 406 and the centralized management system 400 may communicate over a computer network, such as the Internet. The computing device 406 may be operated by advertisers or advertising agencies. When received at the centralized management system 400, the targeted advertisements may be electronically stored in the electronic storage medium 404. The computing device 406 may also transmit target profile information to the centralized management system 400 in association with the targeted advertisements. The target profile information may specify a specific profile of the intended recipients of the targeted advertisements. The centralized management system 400 may compare the target profile to user profiles stored on the electronic storage medium 404 using a computer application running on computing devices 402. The comparison of the target profile to the user profiles may result in a group of targeted users for the targeted advertisements. Thus, it will be understood that the targeted users may have a profile that matches or is close to the targeted profile. This list of targeted users may be stored on the electronic storage medium 404. The computing device 406 may also transmit delivery requirement information to the system 400. The delivery requirement information may be at least one of an ordinal requirement, a timing requirement, and a number requirement.

The targeted advertisements may include individual advertisements intended to be rendered on different platforms. For example, the targeted advertisements may include an advertisement in a format suitable for rendering on a television, an advertisement in a format suitable for rendering on a computer, and an advertisement in a format suitable for rendering on a cellular phone. The centralized management system 400 may be able to manage the delivery of the targeted advertisements across multiple platforms to a targeted user as will be described in more detail below.

A user 412 may enroll with the centralized management system 400 by completing a profile assessment. This may be accomplished via an online survey, personal interview, or any similarly related methodologies. During the enrollment process, the user 412 may provide information relating to his or her profile, which is stored by the centralized management system 400. As mentioned previously, the profile may include information regarding the age of the user 412, the sex of the user 412, income of the user 412, marital and family status of the user 412, the race of the user 412, the native language of the user 412, the credit rating of the user 412, hobbies of the user 412, interests of the user 412, or any other information that can be used to direct targeted advertisements to the user 412.

During the enrollment process, the user 412 may also provide a reference sample for biometric identification purposes. The reference sample may include a reference sample suitable for identifying the user 412 using any biometric recognition technology, including, without limitation, fingerprint recognition, retina recognition, heartbeat recognition, voice recognition, face recognition, and any other technology now known or known in the future that utilizes a measurable, physical characteristic or personal behavioral trait that may be used to recognize the identity, or verify the claimed identity, of a user. The user 412 may also be required to submit information for use with other personal identification technologies, such as passwords, logins, identification numbers, and challenge questions—all of which can be used to identify the user 412.

In return for enrollment, the user 412 may be provided with one or more platforms through which the advertisements may be delivered. Some of the platforms provided to the user 412 may be a type of electronic device. FIG. 4 illustrates examples of some of the suitable platforms in the form of electronic devices that may be provided to the user 412 in return for enrollment with the centralized management system 400. These electronic devices may include a computer 414, a cell phone 416, and a television 418. In addition, the user 412 may be provided with an aftermarket box 420 for enabling a traditional television 422 to be used in accordance with the present disclosure.

Each of the computer 414, phone 416, television 418, and box 420, may have integrated components for enabling two-way electronic communications with the centralized management system 400. These communications may occur over a network, such as the Internet or some other network. The centralized management system 400 may be able to deliver the appropriate targeted advertisements to each of the computer 414, phone 416, the television 418, and the box 420 along with a link identifying the user to whom the advertisement should be rendered, if needed. The targeted advertisements may be saved in a storage medium associated with each of the computer 414, phone 416, television 418, and the box 420 for later rendering. For this reason, it will be appreciated that a targeted advertisement may be transmitted in a format suitable for rendering on the electronic device to which it is sent. In this manner, the present disclosure is able to deliver advertisements across multiple platforms to the same user. The centralized management system 400 may also transmit any delivery requirements for the targeted advertisements.

The computer 414 may include a keyboard 414A, a mouse 414B, a remote control 414C and a camera 414D. The keyboard 414A, mouse 414B and the remote control 414C may each include a biometric sensor for determining the identification of the user 412. The biometric sensor may include, for example, a fingerprint scanner, heartbeat scanner, or a microphone used to capture the voice of the user 412. In one embodiment of the present disclosure, the identity of the user 412 is determined passively. For example, the fingerprint scanner may be located on a control button such that by using the control button, the fingerprint of the user 412 is automatically and passively captured. In another embodiment, the identity of the user is captured actively. For example, the user 412 may be required to speak such that the voice of the user 412 may be captured for recognition. The camera 414D may be used to capture an image of the face of the user 412 for use with facial recognition techniques.

The television 418 may include a remote control 418A. The remote control 418A may include a biometric sensor, including, for example, a fingerprint scanner, a heartbeat scanner, or a microphone. In addition, a camera may be incorporated into the remote control 418A for enabling the use of facial recognition techniques. Once a biometric characteristic or trait is captured, the remote control 418A may transmit this information to the television 418. In addition, the remote control 418A may be used for content selection.

The box 420, attached externally to a conventional television 422, may also include a biometric sensor, including, for example, a fingerprint scanner, a heartbeat scanner, or a microphone. In addition, a camera may be incorporated into the box 420 for enabling the use of facial recognition techniques. The box 420 may use the information to identify the user 412.

It will be appreciated that the use of the biometric recognition techniques allow for the positive identification of instances when the user 412 is actually using the electronic devices, namely the computer 414 and the televisions 418 and 422. Further, these recognition techniques ensure that the targeted advertisements are rendered to the user 412 and not some other party that happens to use any of the electronic devices shown in FIG. 4.

It will be appreciated, that each user of an electronic device may be required to enroll with the centralized management system 400. For example, all of the members of a household may enroll with the system 400. In this case, targeted advertisements for each household member may be sent to the electronic devices 414, 418, and 420 shown in FIG. 4. Further, since the targeted advertisements are stored locally at each electronic device, the targeted advertisements can be rendered to the appropriate user 412 when it is determined that the user 412 is actually using the electronic device through the identification techniques described herein. In other words, a targeted advertisement may not be rendered until it is determined that the user 412 is actually using the one of the electronic devices 414, 418, and 420 shown in FIG. 4.

One embodiment of a manner in which the targeted advertisements are rendered to the user 412 will now be explained for one exemplary embodiment of the present disclosure. In regards to the computer 414, the targeted advertisements may be rendered to the user 412 any time that the user 412 is determined to be using the computer 414 through a biometric recognition technique or another identification technique. In addition, the computer 414 may receive an incoming content stream over a network from a content provider, such as an internet service provider. In an embodiment of the present disclosure, integrated modules in the computer 414 monitor the incoming content stream for targeted advertisement placement opportunities. In addition, if there is a delivery requirement associated with the targeted advertisement, then the computer 414 may monitor the incoming content stream for targeted advertisement placement opportunities that satisfy the delivery requirement.

The computer 414 may be able to replace an advertisement in the content stream with a targeted advertisement directed to the user 412. For example, in the case where the content stream includes a banner ad, the computer 414 may replace the banner ad in the content stream, with a targeted advertisement banner ad. In another embodiment, the incoming content stream may be monitored at a router level instead of at the computer 414. The advertisement placement can then take place at the router level in the same manner described herein. In another embodiment, the incoming content stream may be routed through a proprietary server or gateway. The advertisement placement can take place at this proprietary server or gateway in the same manner described herein. Thus, it should be understood that advertisement placement into a content stream can take place at any point along the path of the content stream between the content provider and the electronic device which renders the content stream. Further, the targeted advertisement placement may take place at the content provider prior to transmission.

Typically, the user 412 may never see the original banner ad transmitted in the content stream, since it is replaced with the targeted advertisement sent by the centralized management system 400. This placement process is facilitated by the fact that the target advertisements are stored locally on the computer 414, a router, or proprietary server, as the case may be. The present disclosure may be able to replace other advertisements typically found on webpages. In addition, the targeted advertisements may be inserted into computer applications running on the computer 414. The computer applications may include computer games and the like.

In regards to the television 418, the targeted advertisements may be rendered to the user 412 in accordance with the delivery requirements, if any, anytime that the user 412 is determined to be watching the television 418 through a biometric recognition technique or another identification technique. For example, the biometric sensor on the remote control 418A may assist in identifying the user 412. The television 418 may have the necessary components for storing and rendering the targeted advertisements integrated into the television 418. The television 418 may also have the necessary components for communicating with the centralized management system 400 integrated therein.

In an embodiment of the present disclosure, after the positive determination that the user 412 is using the television 418, the television 418 may monitor an incoming content stream for an advertisement placement opportunity in accordance with any delivery requirement, if any. The incoming content stream may include, without limitation, broadcast television signals, satellite signals, cable signals, IPTV signals, signals from gaming consoles (Xbox, Playstation, Nintendo), and signals from VCR, DVD, Blue-Ray and HD DVD players. The advertisement placement opportunities may be recognized from embedded signals in the content stream, a programming schedule, or by any other means as previously described.

Once a targeted advertisement placement opportunity has been determined that satisfies any delivery requirement, the targeted advertisement directed specifically to the user 412 is retrieved from a local storage medium and rendered to the user 412 in accordance with the targeted advertisement placement opportunity. Alternatively, the targeted advertisement may be pre-buffered by the television 418 for nearly instantaneous rendering. The rendering of the targeted advertisement may involve displacing an original advertisement in the incoming content stream. However, the user 412 typically may not know that an advertisement in the content stream has been displaced by a targeted advertisement as the targeted advertisement appears to be part of the normal content stream.

In regard to the television 422, it may not have the integrated components to store and render a targeted advertisement to the user 412. The use of the box 420, which has the components necessary for storing and rendering the targeted advertisements received from the centralized management system 400, may allow for the placement of the targeted advertisements in a manner similar to that described in relation to television 418. Further, the box 420 may include biometric recognition technologies for positively identifying when the user 412 is watching the television 422. It will be appreciated that the use of box 420 allows the present disclosure to be used with off-the-shelf consumer products, such as television 422. The box 420 can be adapted to function with other types of electronic devices. The box 420 may further ensure that targeted advertisements are rendered according to any associated delivery requirements.

In regard to the cellular phone 416, the targeted advertisements may be rendered to the user 412 at anytime on a display of the phone 416. Further, the phone 416 may not require the use of a biometric recognition technology due the fact the cellular phones typically do not have multiple users. However, the use of a biometric recognition technology or other identification technique with a cellular phone is within the scope of the present disclosure. The targeted advertisements may be delivered over a cellular phone network from the centralized management system 400. Prior to rendering, the targeted advertisement may be stored in a memory device of the phone 416.

Each of the electronic devices, i.e., computer 414, phone 416, television 418, and box 420 may report the rendering of a targeted advertisement to the user 412 back to the centralized management system 400. This reporting or feedback may be particularly useful in managing an advertising campaign directed to the user 412. For example, once it has been determined that an advertisement has been rendered to the user 412, using any of the electronic devices, computer 414, phone 416, box 420, and television 418, the centralized management system 400 may implement another phase of an advertising campaign. Likewise, the ability of the electronic devices illustrated in FIG. 4, i.e., the computer 414, phone 416, television 418, and box 420 to provide reports or feedback may allow for reports to be sent to computing device 406. Thus, if computing device 406 is operated by advertisers, the advertisers are able to track the progress of the placement of their targeted advertisements in virtually real-time.

As mentioned, the identification of the user 412 may occur passively or actively through the integrated components of the electronic devices, i.e., the computer 414, phone 416, television 418, and box 420, shown in FIG. 4. The integrated components in the electronic devices shown in FIG. 4 may take the form of the components shown in relation to the local management system 202 shown in FIG. 2. Typically, the present disclosure captures the required identification data through the normal use of the electronic devices by the user 412. The centralized management system 400 may comprise several computing devices to accomplish the features described herein. The centralized management system 400 may take the form of the centralized management system 110 illustrated in FIGS. 1 and 3. Additionally, the centralized management system 400 may comprise various servers, including application servers, file transfer servers, and database servers as is known to one having ordinary skill in the art.

A computing device suitable for use as part of the centralized management system 400 will now be described. It will be appreciated that this same description may describe a suitable form for computer 414. The computing device may have various forms, including a desktop PC, a dedicated server, a laptop or a portable tablet form, or a hand held form. The features of the computing device described herein may be integrated or separable from the computing device. For example, while the computing device may have a monitor, it may be integrated into the computing device, such as the case of a laptop or tablet type computer.

The computing device suitable for use as part of the centralized management system 400 or computer 414 may include a system memory and a system bus that interconnects various system components including the system memory to a processing unit. The system bus may be any of several types of bus structures including a memory bus or memory controller, a peripheral bus, and a local bus using any of a variety of bus architectures as is known to those skilled in the relevant art. The system memory may include read only memory (ROM) and random access memory (RAM). A basic input/output system (BIOS), containing the basic routines that help to transfer information between elements within the computing device, such as during start-up, is stored in the ROM. The computing device may further include a hard disk drive for reading and writing information to a hard disk, a magnetic disk drive for reading from or writing to a removable magnetic disk, and an optical disk drive for reading from or writing to a removable optical disk such as a CD ROM, DVD, or other optical media.

It will be appreciated that the hard disk drive, magnetic disk drive, and optical disk drive may be connected to the system bus by a hard disk drive interface, a magnetic disk drive interface, and an optical disk drive interface, respectively. The drives and their associated computer-readable media provide nonvolatile storage of computer readable instructions, data structures, program modules and other data for the computing device. Although the exemplary environment described herein employs a hard disk, a removable magnetic disk, and a removable optical disk, it will be appreciated by those skilled in the relevant art that other types of computer readable media which can store data that is accessible by a computer, such as magnetic cassettes, flash memory cards, digital video disks, Bernoulli cartridges, random access memories, read only memories, and the like, may also be used in the exemplary operating environment.

A number of program modules may be stored on the hard disk, magnetic disk, optical disk, ROM or RAM, including an operating system, one or more applications programs, other program modules, and program data. The application programs may include programs suitable for accomplishing the features and tasks described herein with relation to the centralized management system 400 or the computer 414. A user may enter commands and information into the computing device through input devices such as a keyboard and a pointing device, such as a mouse. These and other input devices are often connected to the processing unit through a serial port interface that is coupled to the system bus. Increasingly, such devices are being connected by the next generation of interfaces, such as a universal serial bus interface with a USB port, and to which other hubs and devices may be connected. Other interfaces (not shown) that may be used include parallel ports, game ports, and the IEEE 1394 specification.

A monitor or other type of display device is also connected to the system bus via an interface, such as a video adapter. In addition to the monitor, the computing device typically includes other peripheral output or input devices. For example, an ultra slim XGA touch panel may be used. A resistive finger touch screen may also be used. Further, it is well understood by those having the relevant skill in the art that a keyboard, scanner, printer, external drives (e.g., hard, disk and optical) and a pointing device may be connected to the computing device suitable for use as part of the centralized management system 400 or the computer 414. In addition, the computing device may be capable of communicating with a network and sending/receiving audio, video and data.

The computing device may operate in a networked environment using logical connections to one or more remote computers or electronic devices as described herein. The types of connections between networked devices include dial up modems, e.g., a modem may be directly used to connect to another modem, ISDN, xDSL, cable modems, wireless and include connections spanning users connected to the Internet. The remote computer may be another personal computer, a server, a router, a network PC, a peer device or other common network node, and typically includes many or all of the elements described in relation to the computing device. In particular, the computing device may be able to communicate with the electronic devices described herein.

When used in a LAN networking environment, the computing device is connected to a local network through a network interface or adapter. The computing device may also connect to the LAN via through any wireless communication standard, such as the 802.11 wireless standard. When used in a WAN networking environment, the computing device typically uses modem or other means for establishing communications over the wide area network. It should be noted that the modem may be internal or external and is connected to the system bus. It will be appreciated that the network connections described herein are exemplary and other means of establishing a communications link between the computers may be used, e.g., from a LAN gateway to WAN.

Generally, the data processors of the computing device suitable for use as part of the centralized management system 400 or the computer 414 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The disclosure described herein includes these and other various types of computer-readable storage media when such media contain instructions or programs for implementing the steps described herein in conjunction with a microprocessor or other data processor. The disclosure also includes the computing device itself when programmed according to the methods and techniques described herein.

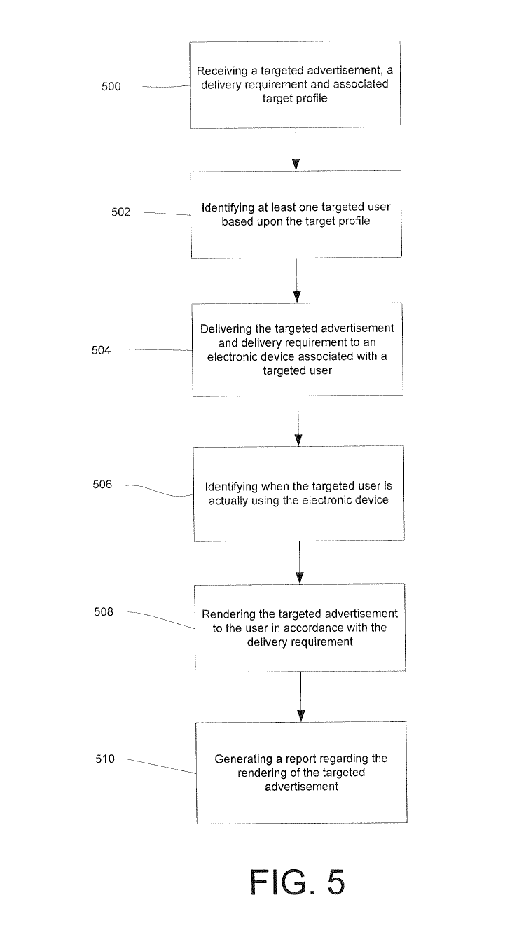

Referring now to FIG. 5, there is depicted a flow diagram according to an embodiment of the present disclosure. At step 500, a targeted advertisement and an associated target profile and delivery requirement may be received at a centralized management system. The targeted advertisement, target profile and the delivery requirement may be transmitted either separately or together over a computer network to the centralized management system. Alternatively, the targeted advertisement, target profile, and the delivery requirement may be delivered to the centralized management system on a portable storage medium where they are loaded into the centralized management system. The centralized management system may comprise a computer database having a plurality of user profiles stored therein. Alternatively, the target profile and delivery requirement may be defined at the centralized management system.

At step 502, a computer application running on the centralized management system may compare the target profile to the user profiles in order to determine a group of targeted users. This comparison may return at least one targeted user. The targeted users may have a profile that matches or is similar to the target profile. At step 504, the targeted advertisement and associated delivery requirement may be delivered to electronic devices of the targeted users. This may be accomplished by transmitting the targeted advertisement and delivery requirement from the centralized management system to one or more electronic devices associated with each targeted user. At step 506, the electronic device of each of the targeted user may determine when the targeted user is actually using the electronic device, and, at step 508, the electronic device may dynamically render the targeted advertisement to the targeted user pursuant to an advertisement placement opportunity that satisfies the delivery requirement. At step 510, a report regarding the rendering of the targeted advertisement may be generated and electronically transmitted back to the centralized management system.

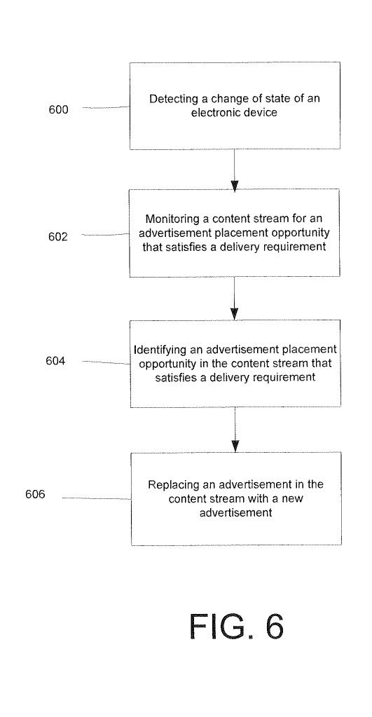

Referring now to FIG. 6, there is depicted a flow diagram according to an embodiment of the present disclosure. At step 600, a change of state is detected in an electronic device. The change of state may include at least one of the electronic device switching from off to on, a change of channel, and any other user initiated state change of the electronic device. Upon the occurrence of the change of state, at step 602, a content stream is monitored for an advertisement placement opportunity that satisfies a delivery requirement. In an embodiment of the present disclosure, the delivery requirement may specify that an advertisement be rendered within a certain range from a change of state of the electronic device. For example, the delivery requirement may specify that the targeted advertisement be rendered with a certain time interval from a change of state of the electronic device. A delivery requirement may specify that the targeted advertisement be rendered with a certain number of advertisements from a change of state of the electronic device. In an embodiment of the present disclosure, a delivery requirement may specify the ordinal, i.e., first, second, third, etc., for rendering the targeted advertisement from a change of state of the electronic device. At step 604, an advertisement placement opportunity is identified in the content stream that satisfies the delivery requirement. At step 606, an advertisement in the content stream is replaced with the desired advertisement.

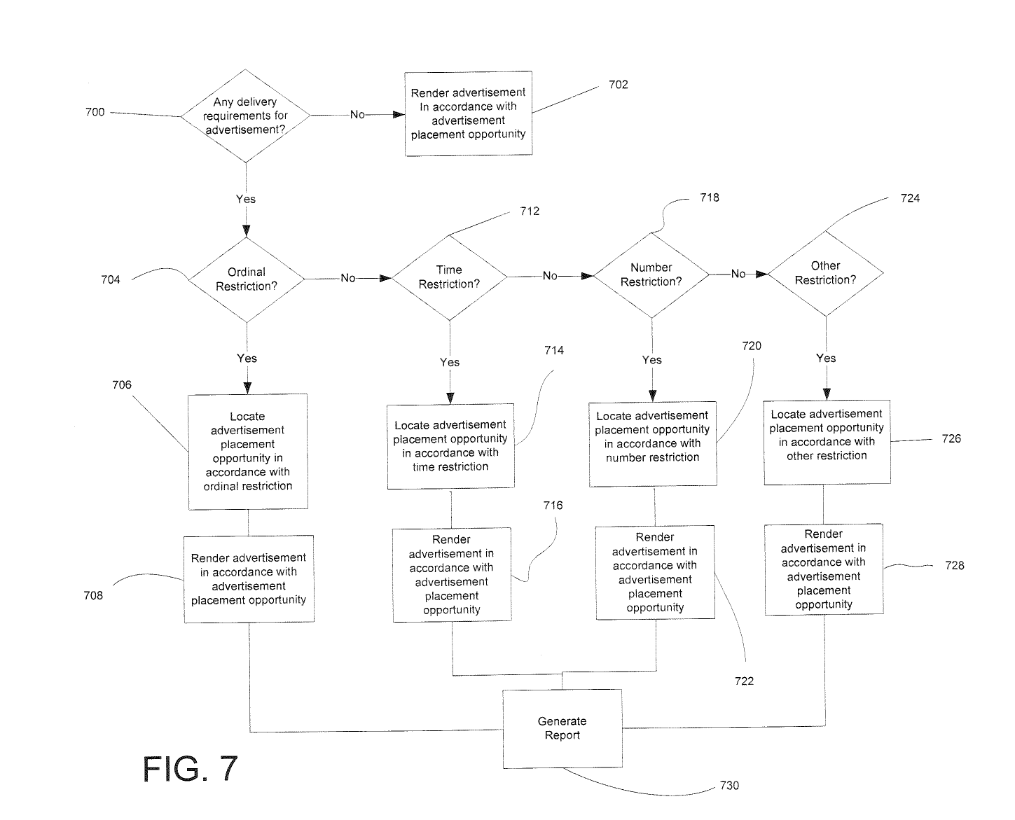

Referring now to FIG. 7, there is depicted a flow diagram according to an embodiment of the present disclosure. At step 700, it is determined whether any delivery requirements are associated with an advertisement. If not, then at step 702 the advertisement is rendered in accordance with an advertisement placement opportunity. If the advertisement is a targeted advertisement, then the advertisement is rendered to a targeted user. If there is a delivery requirement, then at step 704, it is determined if the delivery requirement is an ordinal restriction. An ordinal restriction may specify that the advertisement be the first advertisement rendered to a user after an electronic device has incurred a state change, such as being turned on or changed channels. If the delivery requirement is an ordinal restriction, then at step 706, an advertisement placement opportunity in accordance with the ordinal restriction is determined, and, at step 708, the advertisement is rendered in accordance with the advertisement placement opportunity. If the advertisement is a targeted advertisement, then the advertisement is rendered to a targeted user. At step 710, a report is generated on the placement of the advertisement.

If the delivery requirement is not an ordinal restriction, then at step 712, it is determined whether the delivery requirement is a time restriction. A time restriction may specify that an advertisement be rendered to a user within a certain time interval after a change of state of an electronic device. For example, the time restriction may specify that the advertisement be rendered within the first half-hour from a change of state of the electronic device. If the delivery requirement is a time restriction, then at step 714, an advertisement placement opportunity in accordance with the time restriction is determined. Then, at step 716, the advertisement is rendered in accordance with the advertisement placement opportunity. If the advertisement is a targeted advertisement, then the advertisement is rendered to a targeted user. Then, at step 710, a report is generated on the placement of the advertisement.

If the delivery requirement is not a time restriction, then at step 718, it is determined whether the delivery requirement is a number restriction. A number restriction may specify an interval of a number of advertisements rendered to a user in which the desired advertisement is to be rendered to the user. For example, a number restriction may specify that an advertisement be rendered within the first five advertisements rendered to a user. If the delivery requirement is a number restriction, then at step 720, an advertisement placement opportunity is located in accordance with the number restriction. Then, at step 722, the advertisement is rendered in accordance with the advertisement placement opportunity. If the advertisement is a targeted advertisement, then the advertisement is rendered to a targeted user. At step 710, a report is generated on the placement of the advertisement.

If the delivery requirement is not a number restriction, then at step 724, it is determined whether the delivery requirement is some other restriction. If the delivery requirement is some other restriction, then at step 726 an advertisement placement opportunity is located in accordance with the some other restriction. Then, at step 728, the advertisement is rendered in accordance with the advertisement placement opportunity. If the advertisement is a targeted advertisement, then the advertisement is rendered to a targeted user. At step 710, a report is generated on the placement of the advertisement.

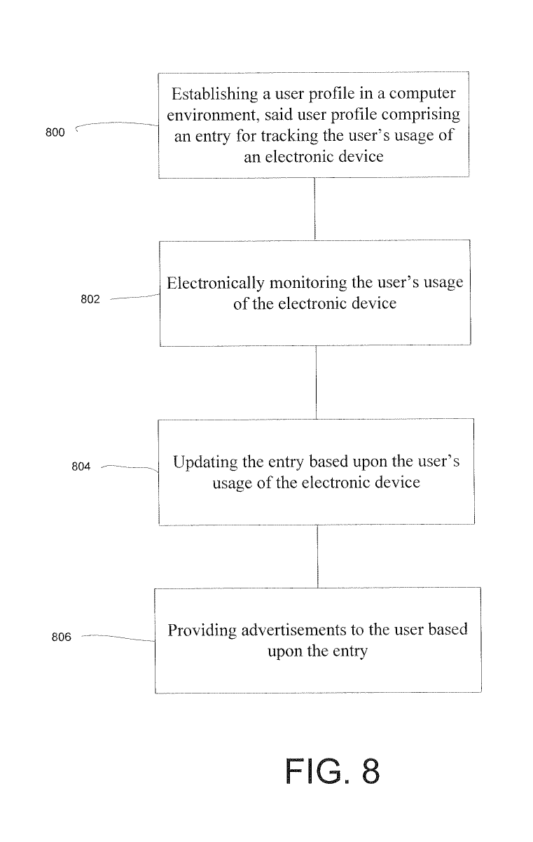

Referring now to FIG. 8, there is depicted a flow diagram according to an embodiment of the present disclosure. At step 800, a user profile is established in a computer environment, such as in an electronic database. The user profile may include an entry for tracking usage information of an electronic device associated with the user. The usage information may include the time spent by the user using the electronic device. At step 802, the electronic device is monitored to determine the usage of the user of the electronic device. At step 804, the entry in the user's profile is updated to reflect the user's usage of the electronic device. For example, the usage may reflect that the usage of the electronic device is two (2) hours per day. At step 806, an advertisement is selected for rendering to the user based upon the user's usage as recorded in the entry of the user profile. That is, the advertisement is selected to be rendered to the user based, at least in part, upon the user's usage level of the electronic device.

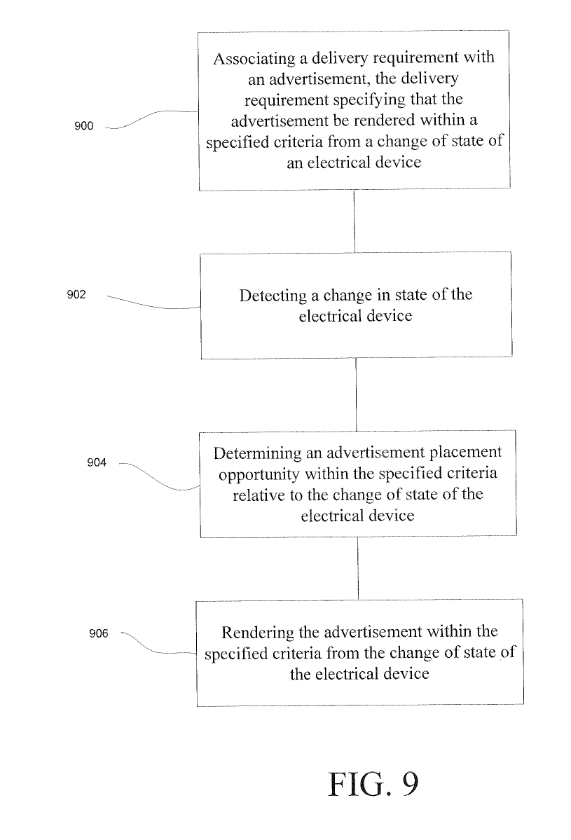

Referring now to FIG. 9, there is depicted a flow diagram according to an embodiment of the present disclosure. At step 900, a delivery requirement is associated with an advertisement. The delivery requirement may specify that the advertisement be rendered to a user within a specified criteria as measured from a change of state of an electronic device. At step 902, a change in state of the electronic device is detected. This may include a channel change, a content change, detecting a targeted user or even turning the electronic device from off to on. At step 904, an advertisement placement opportunity is determined that satisfies the delivery requirement. At step 906, the advertisement is rendered to the user pursuant to the specified criteria as measured from the change of state of the electronic device. In an embodiment of the present disclosure, the specified criteria may include a time restriction or a number restriction.

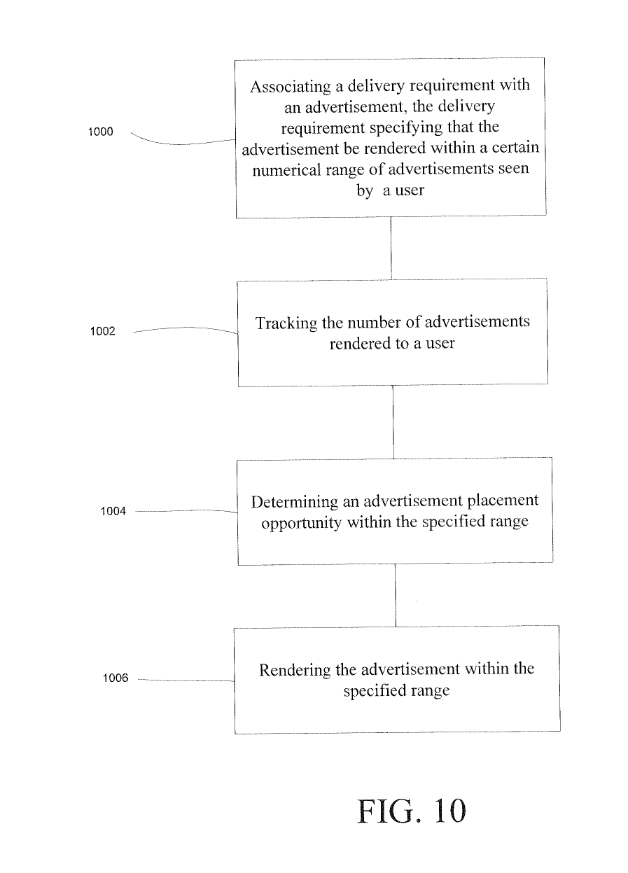

Referring now to FIG. 10, there is depicted a flow diagram according to an embodiment of the present disclosure. At step 1000, a delivery requirement is associated with an advertisement. The delivery requirement may specify that an advertisement be rendered to a user within a specified numerical range of advertisements rendered to the user. At step 1002, the number of advertisements rendered to the user are tracked. This tracking may initiate upon a change of state of the an electronic device. At step 1004, an advertisement placement opportunity is determined within the specified numerical range. At step 1006, the advertisement is rendered to the user within the specified numerical range.

It will be appreciated that in an embodiment of the present disclosure, that the advertisement rendered on an electronic device may or may not be a targeted advertisement. That is, the present disclosure may be suitable for use with non-targeted advertisement as well as targeted advertisements. In particular, delivery requirements may be utilized with both targeted and non-targeted advertisements. As used herein, the term “advertisement” may be understood to refer to both targeted and non-targeted advertisements.

Those having ordinary skill in the relevant art will appreciate the advantages provided by the features of the present disclosure. For example, it is a feature of the present disclosure to provide a system for delivering targeted advertisements to a user of an electronic device. Another feature of the present disclosure is to provide a confirmation or verification that a targeted advertisement has been rendered to a targeted user. It is a further feature of the present disclosure, in accordance with one aspect thereof, to render an advertisement in satisfaction of a delivery requirement. As used in the following claims, the term “content stream” may be construed to incorporate subscription-based content streams as discussed above.

In the foregoing Detailed Description, various features of the present disclosure are grouped together in a single embodiment for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description of the Disclosure by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method for rendering an advertisement using an electronic device, said method comprising:
defining a delivery requirement for the advertisement;
monitoring a content stream for an advertisement placement opportunity in accordance with the delivery requirement;
determining an advertisement placement opportunity in accordance with the delivery requirement;
rendering the advertisement on the electronic device in accordance with the advertisement placement opportunity; and
outputting the advertisement at an output module of the electronic device.

2. The method of claim 1, wherein said delivery requirement requires that the advertisement be rendered on the electronic device within a specified time interval after an occurrence of a predetermined event.

3. The method of claim 2, wherein said predetermined event comprises a change in state of the electronic device.

4. The method of claim 2, wherein said change of state is when the electronic device is switched from off to on.

5. The method of claim 2, wherein said change of state is when a channel of the electronic device is switched from one channel to another channel.

6. The method of claim 2, wherein said change of state is when a volume of the electronic device is increased or decreased.

7. The method of claim 1, wherein said delivery requirement requires that the advertisement be rendered on the electronic device at a specified ordinal location in the content stream.

8. The method of claim 7, wherein the specified ordinal location comprises a placement of the advertisement with respect to other advertisements.

9. The method of claim 7, wherein the specified ordinal location comprises a placement of the advertisement with respect to other advertisements in the content stream as determined from a predetermined event.

10. The method of claim 9, wherein said predetermined event comprises a change in state of the electronic device.

11. The method of claim 1, wherein said delivery requirement requires that the advertisement be rendered on the electronic device within a specified range of advertisements rendered on the electronic device.

12. A method for rendering a targeted advertisement having an associated target profile, said method comprising:
defining a delivery requirement for the targeted advertisement;
comparing the target profile to a plurality of user profiles stored in a database to thereby determine a group of targeted users;
transmitting the targeted advertisement and the delivery requirement over a network to electronic devices associated with each of the targeted users;
rendering the targeted advertisement on the electronic devices of the targeted users in accordance with the delivery requirement; and
outputting the advertisement at an output module of the electronic device.

13. The method of claim 12, wherein said delivery requirement requires that the advertisement be rendered on a given electronic device within a specified time interval after an occurrence of a predetermined event.

14. The method of claim 13, wherein said predetermined event comprises a change in state of the given electronic device.

15. The method of claim 13, wherein said change of state is when the given electronic device is switched from off to on.

16. The method of claim 13, wherein said change of state is when a channel of the given electronic device is switched from one channel to another channel.

17. The method of claim 13, wherein said change of state is when a volume level of the given electronic device is increased or decreased.

18. The method of claim 12, wherein said delivery requirement requires that the advertisement be rendered on a given electronic device at a specified ordinal location in a content stream.

19. The method of claim 18, wherein the specified ordinal location comprises a placement of the advertisement with respect to other advertisements.

20. The method of claim 18, wherein the specified ordinal location comprises a placement of the advertisement with respect to other advertisements in the content stream as determined from a predetermined event.

21. The method of claim 20, wherein said predetermined event comprises a change in state of the electronic device.

22. The method of claim 12, wherein said delivery requirement requires that the advertisement be rendered on a given electronic device within a specified range of advertisements rendered on the electronic device.

23. The method of claim 12, further comprising the step of monitoring a content stream for an advertisement placement opportunity in accordance with the delivery requirement.

24. A method for rendering an advertisement to one or more of a plurality of users, each user having an associated electronic device, said method comprising:
storing usage information for each of the plurality of users in an electronic storage medium;
establishing a usage criteria in association with the advertisement;
determining a group of targeted users from the plurality of users based upon said usage criteria; and
rendering the advertisements to each of the group of targeted users.

25. The method of claim 24, wherein said usage information comprises information regarding an amount of time spent by each user using an associated electronic device.

26. The method of claim 24, wherein storing usage information further comprises storing usage information in a database.

27. The method of claim 24, further comprising storing profile information regarding each of the plurality of users in the electronic storage medium.

28. The method of claim 24, further comprising disseminating the advertisement to the electronic devices of each of the targeted users over a network from a centralized computing system.

29. The method of claim 24, further comprising monitoring at least one content stream for an advertisement placement opportunity.

30. The method of claim 24, further comprising establishing a delivery requirement for the advertisement.

31. The method of claim 30, wherein said delivery requirement requires that the advertisement be rendered to each of the targeted users within a specified time interval after an occurrence of a predetermined event.

32. The method of claim 30, wherein said delivery requirement requires that the advertisement be rendered to each of the targeted users within a specified range of advertisements.

33. The method of claim 30, wherein said delivery requirement requires that the advertisement be rendered to each of the targeted users at a specified ordinal location in a content stream.

34. The method of claim 30, further comprising disseminating the delivery requirement to the electronic devices of each of the targeted users over a network from a centralized computing system.

35. A system for rendering an advertisement using an electronic device, said system comprising:
a delivery requirement management module for defining a delivery requirement for the advertisement;
an advertisement opportunity detection module for monitoring a content stream for an advertisement placement opportunity in accordance with the delivery requirement; and
a rendering module for rendering the advertisement on the electronic device in accordance with the advertisement placement opportunity.

36. The system of claim 35, further comprising a change of state detection module for determining a state of change of the electronic device.

37. The system of claim 35, further comprising a user identification module for determining an identity of a user of the electronic device.

38. The system of claim 35, wherein said advertisement is a targeted advertisement.

39. The system of claim 35, further comprising a switching module for switching a source between the content stream and the advertisement.

40. The system of claim 35, wherein said delivery requirement requires that the advertisement be rendered within a specified time interval after an occurrence of a change of state of the electronic device.

41. The system of claim 35, wherein said delivery requirement requires that the advertisement be rendered within a specified range of advertisements after an occurrence of a change of state of the electronic device.

42. The system of claim 35, wherein said delivery requirement requires that the advertisement be rendered at a specified ordinal location in a content stream after an occurrence of a change of state of the electronic device.

43. A system for disseminating an advertisement to a plurality of electronic devices, said system comprising:
a network gateway module for providing a communication path to each of the plurality of electronic devices;
a delivery requirement management module for defining a delivery requirement for the advertisement;
a pricing management module for determining a price for said advertisement based upon said delivery requirement; and
an advertisement delivery module for transmitting said advertisement and delivery requirement to each of the plurality of electronic devices via said network gateway module.

44. The system of claim 43, wherein said pricing management module implements a pricing structure based upon a parameter as determined from a predetermined event.

45. The system of claim 44, wherein said predetermined event is a change of state of an electronic device.

46. The system of claim 45, wherein said change of state is from a power off state to a power on state.

47. The system of claim 45, wherein said change of state is a change of content.

48. The system of claim 44, wherein said parameter is an ordinal requirement for advertisement placement.

49. The system of claim 44, wherein said parameter is a relative timing for advertisement placement.

50. The system of claim 44, wherein said parameter is a relative number of advertisements rendered to a user before advertisement placement.
